(19) United States
(12) Patent Application Publication
(10) Pub. No.: US 2016/0226406 A1
(43) Pub. Date: Aug. 4, 2016

(54) Variable Voltage Drive using Bidirectional Bipolar Transistors

(71) Applicant: Ideal Power Inc., Austin, TX (US)

(72) Inventors: William C. Alexander, Spicewood, TX (US); Paul A. Bundschuh, Austin, TX (US)

(21) Appl. No.: 14/957,516

(22) Filed: Dec. 2, 2015

Related U.S. Application Data
(60) Provisional application No. 62/086,561, filed on Dec. 2, 2014.

(51) Int. Cl. H02P 1/28; H02P 27/024; H02P 1/46; H02P 25/022

(52) U.S. Cl. CPC H02P 1/28; H02P 25/022; H02P 27/024; H02P 1/46; H02P 2207/01

(57) ABSTRACT

A Variable Voltage Drive (VVD) with highly efficient Bidirectional Bipolar TRANsistor (“B-TRAN”) improves partial load efficiency of AC induction motors.

### CROSS-REFERENCE

Priority is claimed from 62/086,561 filed Dec. 2, 2014, which is hereby incorporated by reference.

### BACKGROUND

The present application relates to motor systems and motor control, and more particularly to fixed-frequency variable-voltage operation of induction motors and the like.

Note that the points discussed below may reflect the hindsight gained from the disclosed inventions, and are not necessarily admitted to be prior art.

A high percentage of the power grid loads are AC induction motors that are used for compressors, fans, pump motors. AC induction motors can be connected directly to the fixed frequency and voltage power grid and operate at constant speed. This simple control method is relatively efficient for constant speed full power and torque loads, but is inefficient for partial load requirements. Many motor drive application that require variable speed or power may use mechanical dampers to reduce the output power effectively wasting a high percentage of the electrical energy input.

The industry has developed Variable Frequency Drives (VFDs) that slow the frequency and the voltage to the motor to improve efficiency for lower load requirements. Conventional VFDs provide a Pulse-Width-Modulation square wave to the motor. This may require a more expensive inverter grade motor, the need to locate the VFD near the motor since the PWM signal does not transmit easily over distances, and potential harmonics back to the grid that can interfere with grid operations.

Another approach of improving AC induction motor efficiency is to reduce the voltage and current to the motor without changing the frequency. This offers a lower cost approach to improving motor efficiency, but it offer less flexibility and potentially less partial load optimization. It can provide soft start/stop capabilities that can extend motor life, and it has less harmonics since pulse-width modulation (PWM) waveforms are not used.

### Variable Voltage Drive Using Bidirectional Bipolar Transistors

The present application teaches, among other innovations, electric motor drive systems, motor control systems, motor control methods, and related components and subsystems. Variable-voltage drive, and in many cases variable-frequency variable-voltage drive, is provided by switchgear which incorporates bidirectional bipolar transistors, such as the “B-TRAN” described in U.S. Pat. No. 9,029,909 (which is hereby incorporated by reference). These transistors are not only fully bidirectional, but also have very low forward voltage drop and other advantages. (For example, these transistors are “robust,” i.e. they recover well from transient overvoltages or overcurrents—as compared with MCTs or IGBTs.)

(All of these concepts have particular synergies and advantages with induction motors in particular, and the embodiments with induction motors are the most preferred.)

The present application also teaches, among other innovations, methods for operating motors, especially but not only induction motors.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 shows a simple example of a fixed-frequency variable-voltage drive configuration according to some disclosed embodiments.

FIG. 2 is a table which compares the drive configuration of FIG. 1 with those of conventional architectures.

Examples of the waveforms provided between the VVD and the AC induction motor are shown in FIGS. 3A, 3B, and 3C.

FIG. 4 shows an example of pulsed chopping to achieve a reduced voltage in the system of FIG. 1.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

Variable Voltage Drives (VVDs) have been used previously, but have not seen widespread use due to the relatively low efficiency. U.S. Pat. No. 9,029,909 (which is hereby incorporated by reference in its entirety) taught B-TRAN power switches, with low conduction losses on the order of 0.3Vdc or less, which permit VVDs to be offered with approximately 99.9% efficiency.

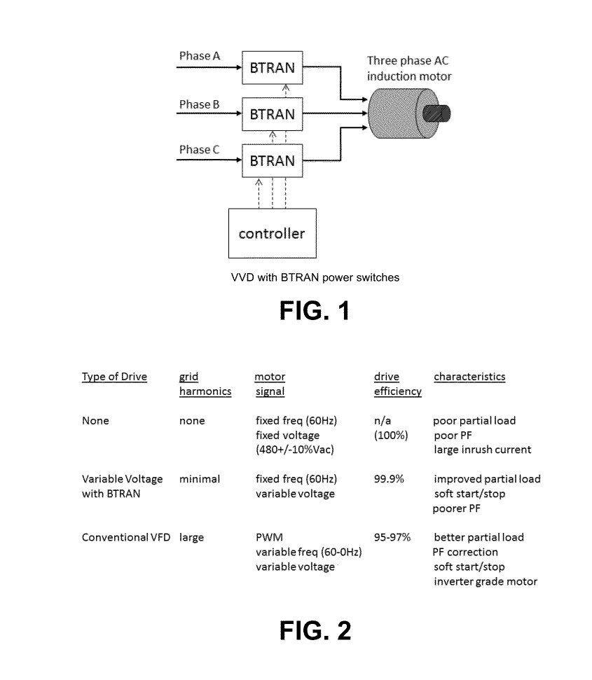

FIG. 1 shows a simple example of a fixed-frequency variable-voltage drive configuration according to some disclosed embodiments. In this example the three “hot” lines of a three-phase power connection are each connected, through a symmetrically-bidirectional bipolar transistor (a “B-TRAN”) to one pole of a three-phase induction motor. A controller operates the three B-TRANs to apply line power, at reduced voltage unless power is being used, to the terminals of the motor. The three B-TRANs can all be switched in unison, or optionally some jitter can be added into the switching times, or optionally more complicated control relations can be used.

The combination of high efficiency, simple operation, and low price will allow VVDs with B-TRANs to be widely adopted as a simple, low cost method to improve motor efficiency. B-TRANs, when implemented in SiC or other semiconductor materials with high voltage breakdown, may be suitable for medium voltage drive applications.

An example of the waveforms provided between the VVD and the AC induction motor are shown in FIGS. 3A, 3B, and 3C.

FIG. 3A shows an example of voltage and current waveforms for an induction motor connected directly to grid power. In this example the motor is assumed to have an inductive power factor.

FIG. 3B shows a first example of voltage and current waveforms for an induction motor which is driven by the VVD configuration of FIG. 1. This example shows operation at greatly reduced voltage, as might be used for soft start or soft stop. In this example the drive voltage is switched on abruptly, about 170 degrees after current zero crossings.

FIG. 3C shows another example of voltage and current waveforms for an induction motor which is driven by the VVD configuration of FIG. 1. This example shows operation at slightly reduced voltage. In this example the drive voltage is switched on abruptly, about 100 degrees after current zero crossings.

FIGS. 3B and 3C show simple examples, where the voltage is only turned on once in each direction during a full cycle of the power line voltage. This example uses phase angle modulation, as a thyristor drive might. However, note that the B-TRAN switches, unlike thyristors, can be turned off. The switch configuration of FIG. 1 thus is capable of much more complex modulation schemes, such as pulse width modulation, pulse length modulation, and various combinations of these.

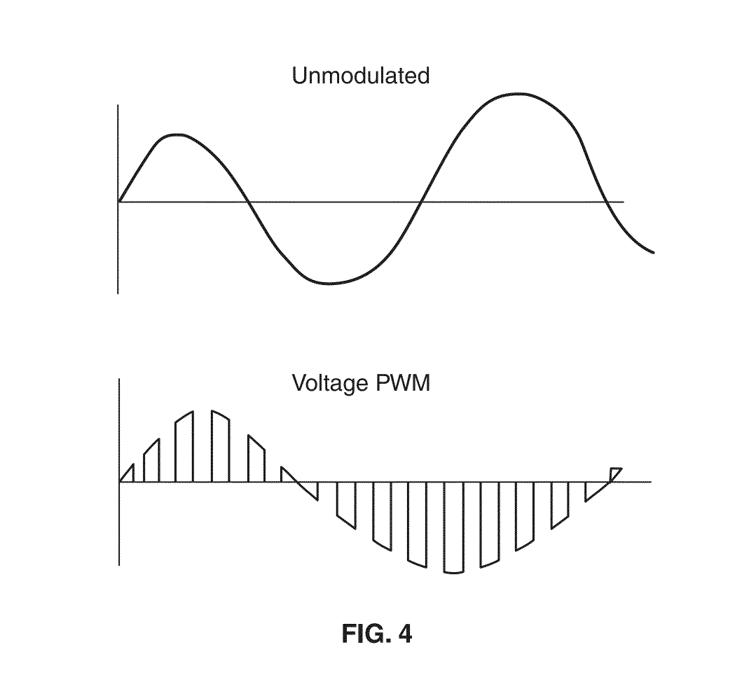

FIG. 4 shows one example of an unmodified power line waveform, together with a pulse train which is produced by switching one of the transistors in FIG. 1 rapidly. The chopped power signal shown will be integrated by the inductance of the motor windings, in combination with any lumped or stray capacitance which may appear at the motor terminals, to produce a reduced-voltage drive.

In this application the switch transitions which produce the sharp voltage slews of FIGS. 3B and 3C, as well as those which produce the pulses of FIG. 4, will be referred to as “chopping.”

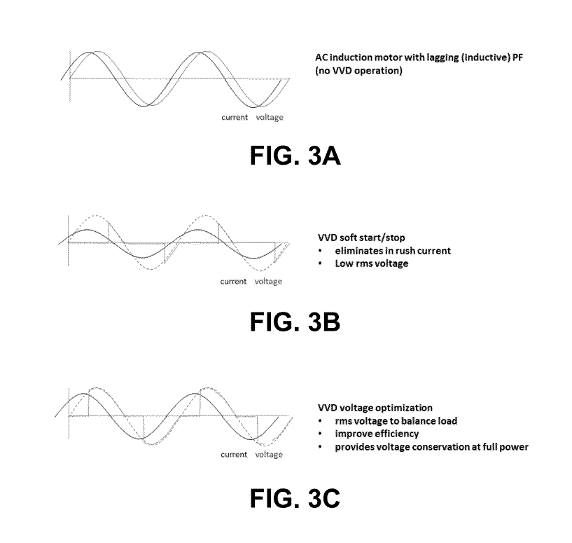

FIG. 2 is a table which compares VVD according to FIG. 1 with conventional VFD, and with no drive at all (i.e. direct connection). When no drive is used, no grid harmonics are present, and the motor signal is at a fixed frequency, e.g. 60 Hz, and a fixed voltage, e.g. 480 VAC±10%. The drive efficiency is necessarily irrelevant, as no drive is used, but can be defined as 100%. This results in a poor partial load, a poor power factor, and a large inrush current.

Using conventional variable frequency drive (VFD), the motor signal is pulse-width modulated (PWM), variable frequency (e.g. 0-60 Hz), and variable voltage. This provides a better partial load, power factor correction, soft start and stop, and inverter-grade motor signal, but also results in large grid harmonics and drive efficiency of about 95-97%.

Using variable voltage drive with B-TRANs, as taught herein, provides a motor signal at a fixed frequency (e.g. 60 Hz) and variable voltage. This provides improved partial loading over the condition when no drive is used, and soft start and stop. While it does result in a worse power factor than does the no-drive condition, this is offset by the minimal grid harmonics and 99.9% drive efficiency, making the present teachings an improvement over both the no-drive condition and conventional variable-frequency drive.

### Advantages

The disclosed innovations, in various embodiments, provide one or more of at least the following advantages. However, not all of these advantages result from every one of the innovations disclosed, and this list of advantages does not limit the various claimed inventions.
Improved efficiency of motor systems.
Improved efficiency of motor operation.
Reduced complexity of high-level control logic.

According to some but not necessarily all embodiments, there is provided: A Variable Voltage Drive (VVD) with highly efficient Bidirectional Bipolar TRANsistor (“B-TRAN”) improves partial load efficiency of AC induction motors.

According to some but not necessarily all embodiments, there is provided: A method of operating an induction or synchronous motor having multiple terminals, comprising the actions of: a) when the motor is being operated under full load, connecting the terminals successively to respective phases of an AC power input through respective symmetrically-bidirectional bipolar power transistors, without any significant frequency shift or voltage reduction; and b) sometimes, when the motor is being operated under part load, connecting the terminals successively to respective phases of the AC power input, using chopping without any frequency shift to provide a reduced net effective AC voltage; and c) when the motor is being started up, connecting the terminals successively to respective phases of the AC power input through respective symmetrically-bidirectional bipolar power transistors, using chopping to provide a net effective AC voltage, at the same frequency as the AC power input, which is gradually increased as the motor shaft speed increases.

According to some but not necessarily all embodiments, there is provided: A method of operating an induction or synchronous motor having multiple terminals, comprising the actions of: a) when the motor is being operated under full load, connecting the terminals successively to respective phases of an AC power input through respective symmetrically-bidirectional bipolar power transistors, without any significant frequency shift or voltage reduction; and b) sometimes, when the motor is being operated under part load, connecting the terminals successively to respective phases of the AC power input, using chopping without any frequency shift to provide a reduced net effective AC voltage.

According to some but not necessarily all embodiments, there is provided: A motor system, comprising: a motor having multiple terminals; an AC power input; a motor controller which, when the motor is being operated under full load, connects the terminals successively to respective phases of the AC power input through respective symmetrically-bidirectional bipolar power transistors, without any significant frequency shift or voltage reduction; and sometimes, when the motor is being operated under part load, connects the terminals successively to respective phases of the AC power input, using chopping without any frequency shift to provide a reduced net effective AC voltage; and when the motor is being started up, connects the terminals successively to respective phases of the AC power input through respective symmetrically-bidirectional bipolar power transistors, using chopping to provide a net effective AC voltage, at the same frequency as the AC power input, which is gradually increased as the motor shaft speed increases.

According to some but not necessarily all embodiments, there is provided: A motor system, comprising: a motor having multiple terminals; an AC power input; a motor controller which, when the motor is being operated under full load, connects the terminals successively to respective phases of the AC power input through respective symmetrically-bidirectional bipolar power transistors, without any significant frequency shift or voltage reduction; and sometimes, when the motor is being operated under part load, connects the terminals successively to respective phases of the AC power input, using chopping without any frequency shift to provide a reduced net effective AC voltage.

According to some but not necessarily all embodiments, there is provided: A motor controller which, when a motor having multiple terminals is being operated under full load, connects the terminals successively to respective phases of an AC power input through respective symmetrically-bidirectional bipolar power transistors, without any significant frequency shift or voltage reduction; and which sometimes, when the motor is being operated under part load, connects the terminals successively to respective phases of the AC power input, using chopping without any frequency shift to provide a reduced net effective AC voltage; and which, when the motor is being started up, connects the terminals successively to respective phases of an AC power input through respective symmetrically-bidirectional bipolar power transistors, using chopping to provide a net effective AC voltage, at the same frequency as the AC power input, which is gradually increased as the motor shaft speed increases.

According to some but not necessarily all embodiments, there is provided: A motor controller: which, when a motor having multiple terminals is being operated under full load, connects the terminals successively to respective phases of an AC power input through respective symmetrically-bidirectional bipolar power transistors, without any significant frequency shift or voltage reduction; and which sometimes, when the motor is being operated under part load, connects the terminals successively to respective phases of the AC power input, using chopping without any frequency shift to provide a reduced net effective AC voltage.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

The disclosed inventions are not only applicable to induction motors, where a current loop is induced in the rotor by slippage, but also to synchronous motors (synchronous machines).

In the most preferred embodiments, the disclosed inventions are implemented in a motor system of between 5 HP and 500 HP. However, this is not a hard limit, and the disclosed inventions can also be advantageously applied to other motor sizes.

In the most preferred embodiments, the disclosed inventions are implemented in a three-phase motor system. However, this is not a hard limit, and the disclosed inventions can also be advantageously applied to single-phase, split-phase, and/or higher-order polyphase systems.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A method of operating an induction or synchronous motor having multiple terminals, comprising the actions of:
a) when the motor is being operated under full load, connecting the terminals successively to respective phases of an AC power input through respective symmetrically-bidirectional bipolar power transistors, without any significant frequency shift or voltage reduction; and
b) sometimes, when the motor is being operated under part load, connecting the terminals successively to respective phases of the AC power input, using chopping without any frequency shift to provide a reduced net effective AC voltage; and
c) when the motor is being started up, connecting the terminals successively to respective phases of the AC power input through respective symmetrically-bidirectional bipolar power transistors, using chopping to provide a net effective AC voltage, at the same frequency as the AC power input, which is gradually increased as the motor shaft speed increases.

2. The method of claim 1, wherein the AC power input is polyphase.

3. The method of claim 1, wherein action c) is performed only when the motor is being operated at less than 90% of full power.

4. The method of claim 1, wherein action c) is performed only when the motor is being operated at less than 50% of full power.

5. The method of claim 1, wherein the chopping comprises phase angle modulation.

6. The method of claim 1, wherein the chopping comprises a pulse train.

7. The method of claim 1, wherein the motor is a synchronous machine.

8. The method of claim 1, wherein the motor is an induction motor.

9. The method of claim 1, wherein the AC power input is medium voltage.

10. The method of claim 1, wherein the AC power input is three-phase, and the motor has a number of terminals which is an integer multiple of 3.

11. A method of operating an induction or synchronous motor having multiple terminals, comprising the actions of:
a) when the motor is being operated under full load, connecting the terminals successively to respective phases of an AC power input through respective symmetrically-bidirectional bipolar power transistors, without any significant frequency shift or voltage reduction; and
b) sometimes, when the motor is being operated under part load, connecting the terminals successively to respective phases of the AC power input, using chopping without any frequency shift to provide a reduced net effective AC voltage.

12. The method of claim 11, wherein the AC power input is polyphase.

13. The method of claim 11, wherein action b) is performed only when the motor is being operated at less than 90% of full power.

14. The method of claim 11, wherein action b) is performed only when the motor is being operated at less than 50% of full power.

15. The method of claim 11, wherein the chopping comprises phase angle modulation.

16. The method of claim 11, wherein the chopping comprises a pulse train.

17. The method of claim 11, wherein the motor is a synchronous machine.

18. The method of claim 11, wherein the motor is an induction motor.

19. The method of claim 11, wherein the AC power input is medium voltage.

20. (canceled)

21. A motor system, comprising:
a motor having multiple terminals;
an AC power input;
a motor controller which,
when the motor is being operated under full load, connects the terminals successively to respective phases of the AC power input through respective symmetrically-bidirectional bipolar power transistors, without any significant frequency shift or voltage reduction; and
sometimes, when the motor is being operated under part load, connects the terminals successively to respective phases of the AC power input, using chopping without any frequency shift to provide a reduced net effective AC voltage; and
when the motor is being started up, connects the terminals successively to respective phases of the AC power input through respective symmetrically-bidirectional bipolar power transistors, using chopping to provide a net effective AC voltage, at the same frequency as the AC power input, which is gradually increased as the motor shaft speed increases.

22-52. (canceled)
